(19) United States
(12) Patent Application Publication
(10) Pub. No.: US 2014/0367105 A1
(43) Pub. Date: Dec. 18, 2014

(54) Filler Particles with Enhanced Suspendability for Use in Hardenable Resin Compositions

(71) Applicant: Halliburton Energy Services, Inc., Houston, TX (US)

(72) Inventors: Jeffery Dwane Karcher, Houston, TX (US); Paul Joseph Jones, Houston, TX (US); Misty Dawn Rowe, Houston, TX (US); Greg Robert Hundt, Houston, TX (US)

(21) Appl. No.: 13/917,894

(22) Filed: Jun. 14, 2013

(51) Int. Cl. C09K 8/42; E21B 33/138; C09K 8/44

(52) U.S. Cl. CPC C09K 8/426; C09K 8/44; E21B 33/138
USPC 166/295

(57) ABSTRACT

Filler particles having an average diameter of about 3 nm to about 20 microns may have enhanced suspendability and be useful in hardenable resin compositions and methods relating thereto. In some instances, a method may include providing a hardenable resin composition that comprises a liquid hardenable resin, a hardening agent, and a plurality of filler particles having an average diameter of about 3 nm to about 20 microns; introducing the hardenable resin composition into a wellbore penetrating a subterranean formation; and allowing the hardenable resin composition to harden to form a resin-based sealant composition in at least a portion of the wellbore, in at least a portion of the subterranean formation, or both.

### BACKGROUND

The present invention relates to filler particles with enhanced suspendability for use in hardenable resin compositions, and methods relating thereto.

Non-cementitious sealants (e.g., as polymer-, resin-, or latex-based sealants) have been used in place of or in conjunction with cementitious compositions (e.g., cement slurries) in primary, secondary, and remedial cementing operations. For example, these compositions may be circulated through the wellbore to plug a void or crack in a conduit or a cement sheath or an opening between the two (e.g., a microannulus). Typically, these sealant compositions are introduced into the wellbore as hardenable resin compositions that includes liquid hardenable resins and hardening agents. Recently, the hardenable resin compositions have also included filler particles to change the density, strength, resiliency, and other mechanical properties of the sealant compositions.

However, the filler particles tend to settle in the hardenable resin compositions, which once hardened yield a sealant composition with variable mechanical properties and density along the length of the sealant composition. These variations in mechanical properties can provide for failure points that, depending on the application, may lead to casing cracking, plug failure, and potentially wellbore collapse. In extreme cases, variations in density may potentially lead to loss of well control.

Typically, additives like surfactants and polymers are utilized to enhance the suspension of particulates in other treatment fluids. However, many surfactants are not compatible with the components of a hardenable resin composition. Therefore, the viscosity of the hardenable resin compositions have increased to mitigate filler particle settling. However, in wellbores with higher bottom hole circulating temperatures, the hardenable resin compositions can experience thermal thinning, which allows for the filler particles to settle. Therefore, a need exists for hardenable resin compositions that include filler particles capable of staying suspended at low viscosities.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 provides an illustrative schematic of a system configured for preparing, transporting, and delivering the hardenable resin compositions described herein to a downhole location.

### DETAILED DESCRIPTION

The present invention relates to filler particles with enhanced suspendability for use in hardenable resin compositions, and methods relating thereto. The features and advantages of the present invention will be readily apparent to those skilled in the art upon a reading of the description of the preferred embodiments that follows.

One embodiment described herein is a method that includes providing a hardenable resin composition that comprises a liquid hardenable resin, a hardening agent, and a plurality of filler particles having an average diameter of about 3 nm to about 20 microns; introducing the hardenable resin composition into a wellbore penetrating a subterranean formation; and allowing the hardenable resin composition to harden to form a resin-based sealant composition in at least a portion of the wellbore, in at least a portion of the subterranean formation, or both.

Another embodiment described herein is a method that includes providing a hardenable resin composition that comprises a liquid hardenable resin, a hardening agent, and a plurality of filler particles having an average diameter of about 3 nm to about 20 microns; introducing the hardenable resin composition into a wellbore penetrating a subterranean formation; placing the liquid hardenable resin in an annulus between the subterranean formation and a conduit disposed within the wellbore; and allowing the hardenable resin composition to harden into a resin-based sealant composition to support the conduit.

Yet another embodiment described herein is a method that includes providing a hardenable resin composition that comprises a liquid hardenable resin, a hardening agent, and a plurality of filler particles having an average diameter of about 3 nm to about 20 microns; introducing the hardenable resin composition into a wellbore penetrating a subterranean formation, the wellbore having a cement sheath disposed in an annulus formed by a conduit and the wellbore; placing the liquid hardenable resin in a void in or proximal to the cement sheath; and allowing the hardenable resin composition to harden into a resin-based sealant composition to plug the void in the cement sheath, wherein the void may optionally be a microannulus.

The filler particles described herein may be sized below about 20 microns (and preferably below about 5 microns) to mitigate settling in hardenable resin compositions, including at higher temperatures where thermal thinning of the hardenable resin compositions may be experienced. The smaller diameter filler particles, optionally in combination with preferred shapes, may provide for hardenable resin compositions capable of yielding more homogeneous resin-based sealant compositions, which mitigates the formation of failure points. Further, with a more homogeneous resin-based sealant composition, the need for secondary and remedial cementing operations may be mitigated, thereby making the well more productive and less costly.

It should be noted that when “about” is provided herein at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

In some embodiments, the hardenable resin compositions described herein may comprise a liquid hardenable resin, a hardening agent, and a plurality of filler particles having a weight average diameter of about 3 nm to about 20 microns. Generally, the liquid hardenable resin and hardening agent are useful in reacting to form a resin-based sealant composition.

As used herein, the term “resin” refers to any of a number of physically similar polymerized synthetics or chemically modified natural resins including thermoplastic materials and thermosetting materials. Examples of liquid hardenable resins may include, but are not limited to, epoxy-based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, bisphenol A diglycidyl ether resins, butoxymethyl butyl glycidyl ether resins, bisphenol A-epichlorohydrin resins, bisphenol F resins, glycidyl ether resins, polyester resins and hybrids and copolymers thereof, polyurethane resins and hybrids and copolymers thereof, acrylate resins, and any combination thereof.

Selection of a suitable liquid hardenable resins may be affected by the temperature of the subterranean formation to which the composition will be introduced. By way of example, for subterranean formations having a bottom hole static temperature (“BHST”) ranging from about 60° F. to about 250° F., two-component epoxy-based resins comprising a hardenable resin component and a hardening agent component in conjunction with specific hardening agents may be preferred. For subterranean formations having a BHST ranging from about 300° F. to about 600° F., a furan-based resin may be preferred. For subterranean formations having a BHST ranging from about 200° F. to about 400° F. either a phenolic-based resin or a one-component high-temperature epoxy-based resin may be suitable. For subterranean formations having a BHST of at least about 175° F., a phenol/phenol formaldehyde/furfuryl alcohol resin may also be suitable.

In some embodiments, the liquid hardenable resins may be included in the hardenable resin compositions described herein in an amount ranging from a lower limit of about 20%, 30%, 40%, 50%, 60%, 70%, or 75% by volume of the hardenable resin composition to an upper limit of about 90%, 80%, or 75% by volume of the hardenable resin composition, and wherein the amount may range from any lower limit to any upper limit and encompasses any subset therebetween. It is within the ability of one skilled in the art with the benefit of this disclosure to determine how much of the liquid hardenable resin may be needed to achieve the desired results, which may depend on, inter alia, the composition of liquid hardenable resin, the composition of the hardening agent, and the relative ratios thereof.

As used herein, the term “hardening agent” refers to any substance capable of transforming the liquid hardenable resin into a hardened, consolidated mass. Examples of suitable hardening agents may include, but are not limited to, aliphatic amines, aliphatic tertiary amines, aromatic amines, cycloaliphatic amines, heterocyclic amines, amido amines, polyamides, polyethyl amines, polyether amines, polyoxyalkylene amines, carboxylic acids, carboxylic anhydrides, triethylenetetraamine, ethylene diamine, N-cocoalkyltrimethylene, isophorone diamine, N-aminophenyl piperazine, imidazoline, 1,2-diaminocyclohexane, polyetheramine, polyethyleneimines, diethyltoluenediamine, 4,4′-diaminodiphenyl methane, methyltetrahydrophthalic anhydride, hexahydrophthalic anhydride, maleic anhydride, polyazelaic polyanhydride, phthalic anhydride, and combinations thereof. Examples of commercially available hardening agents may include, but are not limited to ETHACURE®100 (75%-81% 3,5-diethyltoluene-2,4-diamine, 18%-20% 3,5-diethyltoluene-2,6-diamine, and 0.5%-3% dialkylated m-phenylenediamines, available from Albemarle Corp.) and JEFFAMINE®D-230 (a polyetheramine, available from Huntsman Corp.).

In some embodiments, the hardening agent may comprise a mixture of hardening agents selected to impart particular qualities to the resin-based sealant composition. For example, in particular embodiments, the hardening agent may comprise a fast-setting hardening agent and a slow-setting hardening agent. As used herein, the terms “fast-setting hardening agent” and “slow-setting hardening agent” do not imply any specific rate at which the agents set a hardenable resin; instead, the terms merely indicate the relative rates at which the hardening agents initiate hardening of the resin. Whether as particular hardening agent is considered fast-setting or slow-setting may depend on the other hardening agent(s) with which it is used. In a particular embodiment, ETHACURE® 100 may be used as a slow-setting hardening agent in combination with JEFFAMINE®D-230 as a fast-setting hardening agent. In some embodiments, the ratio of fast-setting hardening agent to slow-setting hardening agent may be selected to achieve a desired behavior of liquid hardening agent component. For example, in some embodiments, the fast-setting hardening agent may at a ratio of approximately 1:5 by volume with the slow-setting hardening agent. With the benefit of this disclosure, one of ordinary skill in the art should be able to select the appropriate ratio of hardening agents for use in a particular application.

In some embodiments, the hardening agent may be included in the hardenable resin compositions in an amount sufficient to at least partially harden the liquid hardenable resin. In some embodiments, the hardening agents may be included in the hardenable resin compositions described herein in an amount ranging from a lower limit of about 1%, 5%, 10%, 25%, or 50% by volume of the liquid hardening agent to an upper limit of about 100%, 75%, or 50% by volume of the liquid hardening agent, and wherein the amount may range from any lower limit to any upper limit and encompasses any subset therebetween.

In some embodiments, the filler particles described herein may have a weight average diameter ranging from a lower limit of about 3 nm, 10 nm, 50 nm, 100 nm, or 250 nm to an upper limit of about 20 microns, 5 microns, 1 micron, or 500 nm, and wherein the weight average diameter may range from any lower limit to any upper limit and encompasses any subset therebetween. The weight average diameter of the particles may preferable provide for enhanced suspension stability of the particles in the hardenable resin composition, thereby yielding a resin-based sealant composition with a more homogeneous dispersion of the filler particles therethrough as compared to a comparable hardenable resin composition with filler particle having a larger weight average diameter without the use of additional suspending aids.

In some embodiments, the filler particles may be included in the hardenable resin compositions described herein in an amount ranging from a lower limit of about 1%, 10%, 25%, or 50% by volume of the hardenable resin composition to an upper limit of about 90%, 75%, 50%, 25%, or 20% by volume of the hardenable resin composition, and wherein the amount may range from any lower limit to any upper limit and encompasses any subset therebetween. The amount of the filler particles in the hardenable resin composition may depend on, inter alia, the weight average diameter of the filler particles, the composition of the filler particles, the shape of the filler particles, the desired density of the hardenable resin composition, and the like. For example, filler particles with high aspect ratios (e.g., fibrous filler particles) may be included at lower concentrations than substantially spherical filler particles because the high aspect ratio filler particles may increase the viscosity (i.e., pumpability) of the hardenable resin composition to a greater degree for a comparable amount.

Examples of suitable filler particles may include, but are not limited to, aluminum oxide, awaruite, barium carbonate, barium oxide, barite, calcium carbonate, calcium oxide, chromite, chromium oxide, copper, copper oxide, dolomite, galena, gold, hematite, a hollow glass microsphere, ilmenite, iron oxide, siderite, magnetite, magnesium oxide, manganese carbonate, manganese dioxide, manganese (IV) oxide, manganese oxide, manganese tetraoxide, manganese (II) oxide, manganese (III) oxide, molybdenum (IV) oxide, molybdenum oxide, molybdenum trioxide, Portland cement, pumice, pyrite, spherelite, silica, silver, tenorite, titania, titanium (II) oxide, titanium (III) oxide, titanium (IV) dioxide, zirconium oxide, zirconium silicate, zinc oxide, cement-kiln dust, unexpanded and expanded perlite, attapulgite, bentonite, zeolite, elastomers, sand, and any combination thereof. It should be noted that the foregoing list encompasses all crystal forms of the material.

In some embodiments, the filler particles may be shaped as spherical, ovular, substantially spherical, substantially ovular, discus, platelet, flake, toroidal (e.g., donut-shaped), dendritic, acicular (e.g., a plurality of slender spikes radiating form a central mass with a spherical, ovular, discus, etc. shape), star or floral shaped (e.g., a tripod or tetrapod where rods or the like extend from a central point), rod-like, fibrous (e.g., high-aspect ratio shapes like fibers or wires), polygonal (e.g., cubic or pyramidal), faceted (e.g., the shape of crystals), irregular (e.g., a ground particle), or any hybrid thereof (e.g., a dumbbell-shape). The shape of the filler particles may be used in addition to the weight average particle size to prevent settling and enhance the homogeneous dispersion of the filler particles in the hardenable resin composition. Examples of such shapes may include, discus, platelet, flake, toroidal, acicular, star or floral shaped, fiberous, rod-like, and the like.

In some embodiments, the filler particles may be formed by grinding methods. While grinding may be more widely available and, in some instances, a less expensive method for producing particles, the shape of the resultant particles are limited to the underlying crystal structure (or lack thereof) of the bulk material.

In some instances, where other particle shapes are desired (e.g., to change the settling tendency of the particle), precipitation methods may be preferred. For example, the conditions of precipitation (e.g., temperature, solvent, salt concentrations, and capping agents) may be altered to achieve varying shapes (e.g., platelets versus acicular) of calcium carbonate, barium sulfate, and the like.

One skilled in the art with the benefit of this disclosure should understand that there are other methods available for forming filler particles described herein (e.g., glass blowing methods for glass microspheres and hollow glass microspheres).

In some embodiments, the filler particles may have a specific gravity of less than about 2.7 (e.g., pumice or hollow glass microspheres). In some embodiments, the filler particles may have a specific gravity ranging from a lower limit of about 0.4, 0.5, 0.7, or 1 to an upper limit of less than about 2.7 or about 2.5, 2, or 1.5, and wherein the multiparticle specific gravity may range from any lower limit to any upper limit and encompasses any subset therebetween. Filler particles with a lower specific gravity may be useful in matching the density of a low density resin, which may reduce the cost of the resin and mitigate shrinkage in addition to the other advantages related to the size of the filler particles ad described herein.

Filler particles described herein with a higher specific gravity may advantageously be useful in increasing the density of the hardenable resin compositions while being maintained in suspension. Such density increases may be useful in wellbore operations that utilize other treatment fluid (e.g., drilling fluids, spacer fluid, and the like) with high density. For example, when displacing a 11 pound per gallon (“ppg”) drilling fluid with a hardenable resin composition described herein, higher specific gravity particles may be utilized to yield a hardenable resin composition with a density greater than 11 ppg. In some embodiments, the filler particles may have a specific gravity of about 2.7 or greater. In some embodiments, the filler particles may have a specific gravity ranging from a lower limit of about 2.7, 3, 4, 4.5, 5, or 5.5 to an upper limit of about 20, 15, 10, 9, 8, or 7, and wherein the multiparticle specific gravity may range from any lower limit to any upper limit and encompasses any subset therebetween.

In some embodiments, the hardenable resin compositions may further comprise at least one of a solvent (e.g., an aqueous diluent or carrier fluid), a silane coupling agent, an accelerator, and any combination thereof.

In some embodiments, a solvent may be added to the hardenable resin compositions to reduce its viscosity for ease of handling, mixing and transferring. However, in particular embodiments, it may be desirable not to use such a solvent for environmental or safety reasons. It is within the ability of one skilled in the art with the benefit of this disclosure to determine if and how much solvent may be needed to achieve a viscosity suitable to the subterranean conditions of a particular application. Factors that may affect this decision include geographic location of the well, the surrounding weather conditions, and the desired long-term stability of the resin-based seal resulting from setting of the hardenable resin compositions.

Generally, any solvent that is compatible with the liquid hardenable resin and that achieves the desired viscosity effect (e.g., degree of hardening) may be suitable for use in the hardenable resin composition. Suitable solvents may include, but are not limited to, polyethylene glycol, butyl lactate, dipropylene glycol methyl ether, dipropylene glycol dimethyl ether, dimethyl formamide, diethylene glycol methyl ether, ethyleneglycol butyl ether, diethyleneglycol butyl ether, propylene carbonate, d-limonene, fatty acid methyl esters, reactive diluents, and combinations thereof. Selection of an appropriate solvent may be dependent on the compositions of the liquid hardenable resin, the concentration of the liquid hardenable resin, and the composition of the hardening agent. With the benefit of this disclosure, the selection of an appropriate solvent should be within the ability of one skilled in the art. In some embodiments, the solvent may be included in the hardenable resin compositions in an amount ranging from a lower limit of about 0.1%, 1%, or 5% by weight of the liquid hardenable resin to an upper limit of about 50%, 40%, 30%, 20%, or 10% by weight of the liquid hardenable resin, and wherein the amount may range from any lower limit to any upper limit and encompasses any subset therebetween. Optionally, the liquid hardenable resin component may be heated to reduce its viscosity, in place of, or in addition to using a solvent.

In some embodiments, the hardenable resin compositions described herein may comprise an accelerator, which accelerates (e.g., via catalysis) the onset and duration of hardening of the hardenable resin compositions to the resin-based sealant composition. Suitable accelerators may include, but are not limited to, organic or inorganic acids like maleic acid, fumaric acid, sodium bisulfate, hydrochloric acid, hydrofluoric acid, acetic acid, formic acid, phosphoric acid, sulfonic acid, alkyl benzene sulfonic acids such as toluene sulfonic acid and dodecyl benzene sulfonic acid (“DDBSA”), phenols, tertiary amines (e.g., 2,4,6-tris(dimethylaminomethyl)phenol, benzyl dimethylamine, and 1,4-diazabicyclo[2.2.2]octane), imidazole and its derivatives (e.g., 2-ethyl,-4-methylimidazole, 2-methylimidazole, and 1-(2-cyanoethyl)-2-ethyl-4-methylimidazole), Lewis acid catalysts (e.g., aluminum chloride, boron trifluoride, boron trifluoride ether complexes, boron trifluoride alcohol complexes, and boron trifluoride amine complexes), and the like, and any combination thereof.

In some embodiments, the hardenable resin composition may be either batch-mixed or mixed on-the-fly. As used herein, the term “on-the-fly” refers to a flowing stream that is continuously introduced into another flowing stream so that the streams are combined and mixed while continuing to flow as a single stream as part of the on-going wellbore operation. Such mixing may also be described as “real-time” mixing. On-the-fly mixing, as opposed to batch or partial batch mixing, may reduce waste and simplify wellbore operations. This is due, in part, to the fact that, in particular embodiments, if the components are mixed and then circumstances dictate that the subterranean treatment be stopped or postponed, the mixed components may become unusable (e.g., in some instances when accelerators are utilized). By having the ability to rapidly shut down the mixing of streams on-the-fly in such embodiments, unnecessary waste may be avoided, resulting in, inter alia, increased efficiency and cost savings.

However, other embodiments of the present invention may allow for batch mixing of the hardenable resin composition. In these embodiments, the hardenable resin composition may be sufficiently stable to allow the composition to be prepared in advance of its introduction into the wellbore without the composition becoming unusable if not promptly introduced into the wellbore. In some instances, a combination of batch and on-the-fly mixing may be utilized where only some of the components of the hardenable resin composition are produced in batches while the remaining components are added on-the-fly.

Generally, the hardenable resin compositions described herein may be used in a variety of wellbore operations in which the resin-based sealant composition may be useful. Some embodiments may involve introducing the hardenable resin composition into a wellbore penetrating a subterranean formation and allowing the hardenable resin composition to harden into a resin-based sealant composition. The hardenable resin composition may be allowed to harden in a variety of places within the wellbore, the subterranean formation, or both.

In some embodiments, introduction into the wellbore may be into a conduit disposed in the wellbore, which is similar to conventional cementing. In some embodiments, introduction into the wellbore may be into a wellbore annulus (e.g., a space between the wellbore and a conduit disposed therein) for remedial operations. It should be noted, that unless otherwise specified or provide for, embodiments that involve introducing into the wellbore include both introduction methods.

For example, some embodiments may involve introducing the hardenable resin composition into a wellbore penetrating a subterranean formation and allowing the hardenable resin composition to harden into a resin-based sealant composition in a portion of the wellbore to isolate the subterranean formation from the portion of the wellbore.

Some embodiments may involve introducing the hardenable resin composition into a wellbore penetrating a subterranean formation; placing the liquid hardenable resin in an annulus between the subterranean formation and a conduit disposed within the wellbore; and allowing the hardenable resin composition to harden into a resin-based sealant composition to support the conduit. Examples of conduits may include, but are not limited to, liners, expandable pipes, pipe string, and the like.

Some embodiments may involve introducing the hardenable resin composition into a wellbore penetrating a subterranean formation; placing the liquid hardenable resin in a void in a conduit disposed within the wellbore; and allowing the hardenable resin composition to harden into a resin-based sealant composition to plug the void in the conduit.

Some embodiments may involve introducing the hardenable resin composition into a wellbore penetrating a subterranean formation, the wellbore having a perforation therein; placing the liquid hardenable resin in the perforation; and allowing the hardenable resin composition to harden into a resin-based sealant composition to plug the void in the perforation.

Some embodiments may involve introducing the hardenable resin composition into a wellbore penetrating a subterranean formation, the wellbore having a cement sheath disposed in an annulus formed by a conduit and the wellbore; placing the liquid hardenable resin in a void in or proximal to the cement sheath (e.g., a microannulus, a crack, or the like); and allowing the hardenable resin composition to harden into a resin-based sealant composition to plug the void in the cement sheath. For example, a microannulus may be a void between the cement sheath and the conduit.

Some embodiments may involve introducing the hardenable resin composition into a wellbore penetrating a subterranean formation; placing the liquid hardenable resin in a portion of the subterranean formation; and allowing the hardenable resin composition to harden into a resin-based sealant composition to reduce or prevent fluid flow between the wellbore and the portion of the subterranean formation (e.g., for diverting subsequent treatment fluids away from the portion of the subterranean formation).

Some embodiments may involve introducing the hardenable resin composition into a wellbore penetrating a subterranean formation, the subterranean formation having a lost circulation zone; placing the liquid hardenable resin in the lost circulation zone; and allowing the hardenable resin composition to harden into a resin-based sealant composition to reduce or prevent fluid flow between the wellbore and the lost circulation zone. In some instances, the lost circulation zone may comprise voids in the subterranean formation, a vugular zone of the subterranean formation, fractures in the subterranean formation, and any combination thereof.

Some embodiments may involve introducing the hardenable resin composition into a wellbore penetrating a subterranean formation; placing the liquid hardenable resin in a portion of the wellbore; and allowing the hardenable resin composition to harden into a resin-based sealant composition to plug the portion of the wellbore (e.g., for abandonment, for zonal isolation, and the like).

In some instances, including in the foregoing embodiments for placing the hardenable resin composition, the hardenable resin composition may be introduced in series with other fluids. For example, introducing in order the hardenable resin composition, a cement slurry, and a displacement fluid. In another example, introducing a drilling fluid, the hardenable resin composition, and a displacement fluid. Further, a spacer fluid may be introduced between any of the foregoing fluids. As such, the filler particles described herein may be useful in tailoring the density of the hardenable resin composition to minimize mixing of adjacent fluids. Mixing of fluids can lead to ineffective hardening of the hardenable resin composition or cement slurries and, consequently, create points of potential failure in the corresponding hardened composition.

In various embodiments, systems configured for preparing, transporting, and delivering the hardenable resin compositions described herein to a downhole location are described. In various embodiments, the systems can comprise a pump fluidly coupled to a tubular (e.g., a casing, drill pipe, production tubing, coiled tubing, etc.) extending into a wellbore penetrating a subterranean formation, the tubular may be configured to circulate or otherwise convey a hardenable resin composition that comprises a liquid hardenable resin, a hardening agent, and a plurality of filler particles having an average diameter of about 3 nm to about 20 microns. The pump may be, for example, a high pressure pump or a low pressure pump, which may depend on, inter alia, the viscosity and density of the hardenable resin composition, the type of the cementing operation, and the like.

In some embodiments, the systems described herein may further comprise a mixing tank arranged upstream of the pump and in which the hardenable resin composition is formulated. In various embodiments, the pump (e.g., a low pressure pump, a high pressure pump, or a combination thereof) may convey the hardenable resin composition from the mixing tank or other source of the hardenable resin composition to the tubular. In other embodiments, however, the hardenable resin composition can be formulated offsite and transported to a worksite, in which case the hardenable resin composition may be introduced to the tubular via the pump directly from a transport vehicle or a shipping container (e.g., a truck, a railcar, a barge, or the like) or from a transport pipeline. In yet other embodiments, the cementing fluid may be formulated on the fly at the well site where components of the cementing fluid are pumped from a transport (e.g., a vehicle or pipeline) and mixed during introduction into the tubular. In any case, the hardenable resin composition may be drawn into the pump, elevated to an appropriate pressure, and then introduced into the tubular for delivery downhole.

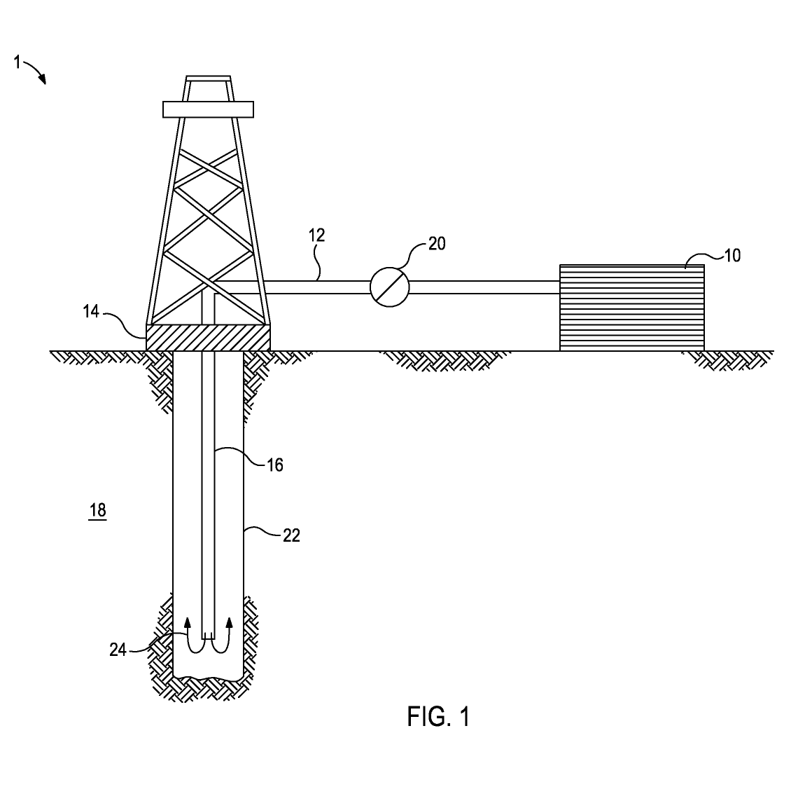

FIG. 1 shows an illustrative schematic of a system that can deliver hardenable resin compositions described herein to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which a hardenable resin composition described herein may be formulated. Again, in some embodiments, the mixing tank 10 may represent or otherwise be replaced with a transport vehicle or shipping container configured to deliver or otherwise convey the cementing fluid to the well site. The hardenable resin composition may be conveyed via line 12 to wellhead 14, where the hardenable resin composition enters tubular 16 (e.g., a casing, drill pipe, production tubing, coiled tubing, etc.), tubular 16 extending from wellhead 14 into wellbore 22 penetrating subterranean formation 18. Upon being ejected from tubular 16, the hardenable resin composition may subsequently return up the wellbore in the annulus between the tubular 16 and the wellbore 22 as indicated by flow lines 24. In other embodiments, the cementing fluid may be reverse pumped down through the annulus and up tubular 16 back to the surface, without departing from the scope of the disclosure. Pump 20 may be configured to raise the pressure of the hardenable resin composition to a desired degree before its introduction into tubular 16 (or annulus). It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensors, adapters, joints, gauges, sensors, compressors, pressure controllers, pressure sensors, flow rate controllers, flow rate sensors, temperature sensors, and the like.

One skilled in the art, with the benefit of this disclosure, should recognize the changes to the system described in FIG. 1 to provide for other cementing operations (e.g., squeeze operations, reverse cementing (where the cement in introduced into an annulus between a tubular and the wellbore and returns to the wellhead through the tubular), and the like).

It is also to be recognized that the disclosed hardenable resin compositions may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), wellbore projectiles (e.g., wipers, plugs, darts, balls, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

Embodiments Disclosed Herein Include:

A. a method that includes providing a hardenable resin composition that comprises a liquid hardenable resin, a hardening agent, and a plurality of filler particles having an average diameter of about 3 nm to about 20 microns; introducing the hardenable resin composition into a wellbore penetrating a subterranean formation; and allowing the hardenable resin composition to harden to form a resin-based sealant composition in at least a portion of the wellbore, in at least a portion of the subterranean formation, or both;

B. a method that includes providing a hardenable resin composition that comprises a liquid hardenable resin, a hardening agent, and a plurality of filler particles having an average diameter of about 3 nm to about 20 microns; introducing the hardenable resin composition into a wellbore penetrating a subterranean formation; placing the liquid hardenable resin in an annulus between the subterranean formation and a conduit disposed within the wellbore; and allowing the hardenable resin composition to harden into a resin-based sealant composition to support the conduit; and

C. a method that includes providing a hardenable resin composition that comprises a liquid hardenable resin, a hardening agent, and a plurality of filler particles having an average diameter of about 3 nm to about 20 microns; introducing the hardenable resin composition into a wellbore penetrating a subterranean formation, the wellbore having a cement sheath disposed in an annulus formed by a conduit and the wellbore; placing the liquid hardenable resin in a void in or proximal to the cement sheath; and allowing the hardenable resin composition to harden into a resin-based sealant composition to plug the void in the cement sheath, wherein the void may optionally be a microannulus.

Each of embodiments A, B, and C may have one or more of the following additional elements in any combination:

Element 1: the plurality of filler particles having the average diameter of about 100 nm to about 5 microns; Element 2: the plurality of filler particles having the average diameter of about 3 nm to about 250 nm; Element 3: the plurality of filler particles having a specific gravity of about 0.1 g/cm³ to about 20 g/cm³; Element 4: at least some of the filler particles being precipitated particles; Element 5: at least some of the filler particles having a shape selected from the group consisting of ovular, discus, platelet, flake, toroidal, acicular, polygonal, faceted, star-shaped, and any hybrid thereof; Element 6: at least some of the filler particles being hollow spheres; Element 7: at least some of the filler particles comprising at least one selected from the group consisting of aluminum oxide, awaruite, barium carbonate, barium oxide, barite, calcium carbonate, calcium oxide, chromite, chromium oxide, copper, copper oxide, dolomite, galena, gold, hematite, a hollow glass microsphere, ilmenite, iron oxide, siderite, magnetite, magnesium oxide, manganese carbonate, manganese dioxide, manganese (IV) oxide, manganese oxide, manganese tetraoxide, manganese (II) oxide, manganese (III) oxide, molybdenum (IV) oxide, molybdenum oxide, molybdenum trioxide, Portland cement, pumice, pyrite, spherelite, silica, silver, tenorite, titania, titanium (II) oxide, titanium (III) oxide, titanium (IV) dioxide, zirconium oxide, zirconium silicate, zinc oxide, cement-kiln dust, unexpanded and expanded perlite, attapulgite, bentonite, zeolite, elastomers, sand, and any combination thereof; Element 8: the plurality of filler particles being present in an amount of about 1% to about 45% by volume of the hardenable resin composition; Element 9: the liquid hardenable resin comprising a component selected from the group consisting of epoxy-based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, and acrylate resins; Element 10: the hardening agent comprising a component selected from the group consisting of aliphatic amines, aliphatic tertiary amines, aromatic amines, cycloaliphatic amines, heterocyclic amines, amido amines, polyamides, polyethyl amines, polyether amines, polyoxyalkylene amines, carboxylic anhydrides, triethylenetetraamine, ethylene diamine, N-cocoalkyltrimethylene, isophorone diamine, N-aminophenyl piperazine, imidazoline, 1,2-diaminocyclohexane, polytheramine, diethyltoluenediamine, 4,4′-diaminodiphenyl methane, methyltetrahydrophthalic anhydride, hexahydrophthalic anhydride, maleic anhydride, polyazelaic polyanhydride, and phthalic anhydride; Element 11: wherein the resin-based sealant composition isolates the portion of the wellbore from the subterranean formation; Element 12: wherein the wellbore has a conduit disposed therein, and wherein the resin-based sealant composition forms in the portion of the wellbore to support the conduit; Element 13: wherein the wellbore has a conduit disposed therein, and wherein the resin-based sealant composition forms in the portion of the wellbore to support the conduit; Element 14: wherein the wellbore has a cement sheath disposed therein, and wherein the resin-based sealant composition forms in the portion of the wellbore to plug a void in the cement sheath; Element 15: wherein the portion of the subterranean formation is a lost circulation zone, and wherein the resin-based sealant composition forms in the portion of the lost circulation zone to reduce or prevent fluid flow between the wellbore and the lost circulation zone; and Element 16: wherein the resin-based sealant composition forms in the portion of the wellbore to plug the portion of the wellbore.

By way of non-limiting example, exemplary combinations applicable to A, B, C include: Element 1 in combination with at least one of Elements 3, 7, 9, 10, and 11; Element 2 in combination with at least one of Elements 3, 7, 9, 10, and 11; Element 3 in combination with at least one of Elements 7, 9, 10, and 11; Element 7 in combination with at least one of Elements 9, 10, and 11; Element 4 in combination with any of the foregoing; Element 5 in combination with any of the foregoing; Element 8 in combination with any of the foregoing; two or more of Elements 9-11 in combination; one of elements 12-16 in combination with any of the foregoing;

While compositions and methods are described in terms of “comprising” various components or steps, the compositions and methods can also “consist essentially of” or “consist of” the various components and steps. When “comprising” is used in a claim, it is open-ended.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention disclosed herein are presented below. Not all features of an actual implementation are described or shown in this application for the sake of clarity. It is understood that in the development of an actual embodiment incorporating the present invention, numerous implementation-specific decisions must be made to achieve the developer's goals, such as compliance with system-related, business-related, government-related and other constraints, which vary by implementation and from time to time. While a developer's efforts might be complex and time-consuming, such efforts would be, nevertheless, a routine undertaking for those of ordinary skill the art having benefit of this disclosure.

To facilitate a better understanding of the present invention, the following examples of preferred or representative embodiments are given. In no way should the following examples be read to limit, or to define, the scope of the invention.

### EXAMPLES

Samples were prepared with 400 g of WELLLOCK™ R-1 (a resin system, available from Halliburton Energy Services, Inc.), 108 g of WELLLOCK™ H1 (a resin hardener, available from Halliburton Energy Services, Inc.), and filler particles at a concentration to achieve a final density of about 12 ppg. The filler particles tested were 325 mesh ground barite (about 45 micron average diameter), silica flour (about 74 micron average diameter), microsand (about 5 micron average diameter), and titania nanoparticles (about 200 nm average diameter), micronized barite (BARIMITE™ XF, about 2.5 micron average diameter, available from Cimbar), and micronized zirconia (about 5 micron average diameter).

To analyze the settling of the filler particles, the samples were mixed then cured at 120° F. in sealed 2″×4″ plastic cylinders in a water bath at atmospheric pressure for 48 hours. After curing, the samples were cut into four equal sections and the density of each section was determined via Archimedes' principle, results presented in Table 1.

TABLE 1

| | Average | | | | Density | Density |
|---|---|---|---|---|---|---|
| Weighting | Particle | | | Density | Difference | Difference |
| Agent | Size | | Segment | (ppg) | (ppg) | (%) |
| 325 Mesh | 45 | μm | 1 | 10.09 | 8.34 | 45.25 |
| Barite | | | 2 | 10.93 | | |
| | | | 3 | 11.09 | | |
| | | | 4 | 18.43 | | |
| Barimite | 2.5 | μm | 1 | 12.43 | 0.42 | 3.25 |
| XF | | | 2 | 12.51 | | |
| | | | 3 | 12.51 | | |
| | | | 4 | 12.84 | | |
| Silica | 74 | μm | 1 | 10.76 | 4.42 | 29.12 |
| Flour | | | 2 | 11.51 | | |
| | | | 3 | 11.93 | | |
| | | | 4 | 15.18 | | |
| Microsand | 5 | μm | 1 | 12.34 | 0.17 | 1.33 |
| | | | 2 | 12.34 | | |
| | | | 3 | 12.34 | | |
| | | | 4 | 12.51 | | |
| TiO₂ | 200 | nm | 1 | 12.34 | 0.08 | 0.67 |
| | | | 2 | 12.34 | | |
| | | | 3 | 12.34 | | |
| | | | 4 | 12.43 | | |
| ZrO₂ | 5 | μm | 1 | 12.34 | 0.33 | 2.63 |
| | | | 2 | 12.43 | | |
| | | | 3 | 12.43 | | |
| | | | 4 | 12.68 | | |

The rheological properties of the samples was analyzed with a Fann 35 Rheometer with a Yield Stress Adapter (FYSA), the results presented in Table 2.

TABLE 2

| Weighting | | | | | | 3 RPM | 6 RPM |
|---|---|---|---|---|---|---|---|
| Agent | 3 RPM | 6 RPM | 100 RPM | 200 RPM | 300 RPM | Delay | Delay |
| 325 Mesh | 2/1 | 3/2 | 38/38 | 75/75 | 112 | 1 | 1 |
| Barite | | | | | | | |
| Barimite XF | 1/1 | 2/2 | 25/25 | 49/49 | 73 | 0 | 0 |
| Silica Flour | 2/2 | 4/4 | 57/57 | 112/112 | 166 | 0 | 1 |
| Microsand | 2/2 | 4/4 | 62/61 | 118/116 | 171 | 1 | 1 |
| TiO₂ | 2/2 | 3/3 | 42/41 | 81/79 | 117 | 0 | 1 |
| ZrO₂ | 1/1 | 2/2 | 29/28 | 56/56 | 84 | 1 | 1 |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a hardenable resin composition that comprises a liquid hardenable resin, a hardening agent, and a plurality of filler particles having an average diameter of about 3 nm to about 20 microns;
introducing the hardenable resin composition into a wellbore penetrating a subterranean formation; and
hardening the hardenable resin composition to form a resin-based sealant composition in at least a portion of the wellbore, in at least a portion of the subterranean formation, or both.

2. The method of claim 1, wherein the plurality of filler particles have the average diameter of about 100 nm to about 5 microns.

3. The method of claim 1, wherein the plurality of filler particles have the average diameter of about 3 nm to about 250 nm.

4. The method of claim 1, wherein the plurality of filler particles have a specific gravity of about 0.1 g/cm³ to about 20 g/cm³.

5. The method of claim 1, wherein at least some of the filler particles are precipitated particles.

6. The method of claim 1, wherein at least some of the filler particles have a shape selected from the group consisting of ovular, discus, platelet, flake, toroidal, acicular, polygonal, faceted, star-shaped, and any hybrid thereof.

7. The method of claim 1, wherein at least some of the filler particles are hollow spheres.

8. The method of claim 1, wherein the filler particles comprise at least one selected from the group consisting of aluminum oxide, awaruite, barium carbonate, barium oxide, barite, calcium carbonate, calcium oxide, chromite, chromium oxide, copper, copper oxide, dolomite, galena, gold, hematite, a hollow glass microsphere, ilmenite, iron oxide, siderite, magnetite, magnesium oxide, manganese carbonate, manganese dioxide, manganese (IV) oxide, manganese oxide, manganese tetraoxide, manganese (II) oxide, manganese (III) oxide, molybdenum (IV) oxide, molybdenum oxide, molybdenum trioxide, Portland cement, pumice, pyrite, spherelite, silica, silver, tenorite, titania, titanium (II) oxide, titanium (III) oxide, titanium (IV) dioxide, zirconium oxide, zirconium silicate, zinc oxide, cement-kiln dust, unexpanded and expanded perlite, attapulgite, bentonite, zeolite, elastomers, sand, and any combination thereof.

9. The method of claim 1, wherein the plurality of filler particles are present in an amount of about 1% to about 45% by volume of the hardenable resin composition.

10. The method of claim 1, wherein the liquid hardenable resin comprises a component selected from the group consisting of epoxy-based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, and acrylate resins.

11. The method of claim 1, wherein the hardening agent comprises a component selected from the group consisting of aliphatic amines, aliphatic tertiary amines, aromatic amines, cycloaliphatic amines, heterocyclic amines, amido amines, polyamides, polyethyl amines, polyether amines, polyoxyalkylene amines, carboxylic anhydrides, triethylenetetraamine, ethylene diamine, N-cocoalkyltrimethylene, isophorone diamine, N-aminophenyl piperazine, imidazoline, 1,2-diaminocyclohexane, polytheramine, diethyltoluenediamine, 4,4′-diaminodiphenyl methane, methyltetrahydrophthalic anhydride, hexahydrophthalic anhydride, maleic anhydride, polyazelaic polyanhydride, and phthalic anhydride.

12. The method of claim 1, wherein the resin-based sealant composition isolates the portion of the wellbore from the subterranean formation.

13. The method of claim 1, wherein the wellbore has a conduit disposed therein, and wherein the resin-based sealant composition forms in the portion of the wellbore to support the conduit.

14. The method of claim 1, wherein the wellbore has a cement sheath disposed therein, and wherein the resin-based sealant composition forms in the portion of the wellbore to plug a void in the cement sheath.

15. The method of claim 1, wherein the portion of the subterranean formation is a lost circulation zone, and wherein the resin-based sealant composition forms in the portion of the lost circulation zone to reduce or prevent fluid flow between the wellbore and the lost circulation zone.

16. The method of claim 1, wherein the resin-based sealant composition forms in the portion of the wellbore to plug the portion of the wellbore.

17. A method comprising:
providing a hardenable resin composition that comprises a liquid hardenable resin, a hardening agent, and a plurality of filler particles having an average diameter of about 3 nm to about 20 microns;
introducing the hardenable resin composition into a wellbore penetrating a subterranean formation;
placing the liquid hardenable resin in an annulus between the subterranean formation and a conduit disposed within the wellbore; and
hardening the hardenable resin composition into a resin-based sealant composition to support the conduit.

18. A method comprising:
providing a hardenable resin composition that comprises a liquid hardenable resin, a hardening agent, and a plurality of filler particles having an average diameter of about 3 nm to about 20 microns;
introducing the hardenable resin composition into a wellbore penetrating a subterranean formation, the wellbore having a cement sheath disposed in an annulus formed by a conduit and the wellbore;
placing the liquid hardenable resin in a void in or proximal to the cement sheath; and
hardening the hardenable resin composition into a resin-based sealant composition to plug the void in the cement sheath.

19. The method of claim 18, wherein the void is a microannulus.
